(19) United States
(12) Patent Application Publication
(10) Pub. No.: US 2020/0070916 A1
(43) Pub. Date: Mar. 5, 2020

(54) USB/SOLAR RECHARGEABLE, GENERATOR HUB COMPATIBLE POWER CELL/INTEGRATED LED BICYCLE HANDLEBAR/SEATPOST/SADDLE LIGHTS

(71) Applicant: Jesse T. Iozzio, Brooklyn, NY (US)

(72) Inventor: Jesse T. Iozzio, Brooklyn, NY (US)

(21) Appl. No.: 16/116,424

(22) Filed: Aug. 29, 2018

(51) Int. Cl. B62J 6/02; B62J 6/18; B62J 6/00; B62J 99/00

(52) U.S. Cl. CPC B62J 6/02; B62J 6/18; B62J 2099/008; B62J 99/00; B62J 6/003

(57) ABSTRACT

An integrated bicycle lighting assembly which allows for both frontward and rearward bicycle illumination that can be fixed to the bicycle via rivet or bolt and which is adjustable, controllable via a controller on the handlebar, and includes a power source which has the ability to be removed or coupled with a solar panel or dyno generator.

### BACKGROUND OF THE INVENTION

### Technical Field of the Invention

The present invention is related to bicycle lighting systems, such as headlights or tail lights, which are integrated into or bolted onto a bicycle utilizing adjustable, and changeable lighting sources in addition to rechargeable or regenerating power sources.

### Description of the Related Art

Visibility in dim light is a concern among cyclists. Riding without proper lights is hazardous on both open highways and city streets. In particular, forward-facing headlights and rearward-facing tail lights improve the safety of the rider by alerting others utilizing the roads to the presence of the cyclist and also illuminating the road so that the cyclist can more easily navigate the road. The availability of bicycle lighting which allows for illuminated lights (intermittent or otherwise) is important to communicate cyclist movement and enable safe navigation of roadways. In particular, cycling would be improved by the ability to secure lights to various places on a bicycle. An integrated, easy, and safe method for utilizing these intermittent lighting functions is important to allow the cyclist to gain the benefit of these advantages while riding Likewise, the availability of bicycle lighting which allows for adjustment of the lighting angle or intensity is important to enable a cyclist to view appropriate portions of the road or obstacles which are stationed on the road.

Maximizing efficiency and performance is a trend in cycling that has yet to be established in conjunction with bicycle lights. Specifically, light-weight bicycle lighting systems reduce the overall weight of the bicycle and minimize improper weight distribution. Minimization of the weight distribution disturbance and minimal additional weight is preferred in cycling, both in performance situations and everyday casual enjoyment riding. Likewise, ensuring that the bicycle lighting maintains sufficient charge to be useable when lighting is most necessary is critical. In particular, the ability to ensure that the lighting power source remains charged or is easily recharged without the use of cumbersome and unavailable tools will ensure safe and efficient performance on the bicycle under dim or unlighted conditions. There has long been an unmet need for this ability.

Present day devices are subject to theft in urban areas if left unattended. Accessory lights, which are added to a bicycle by way of an attachment, are more likely to be noticed as additions to the bicycle and more likely to be able to be easily detached. If a bicycle is left unattended, both of these characteristics make the bicycle lighting more likely to be stolen or damaged. In addition, these bicycle attachments diminish the overall aesthetic of the bicycle, as well as cause setbacks in bicycle performance in terms of aerodynamics. These attachments are often large and cumbersome, occupying the limited handlebar space and diminishing the performance of the bicycle. Riders have long desired these features to be built into the bicycle or able to be fastened securely to the bicycle Likewise, attachments for rearward-facing tail lights have the potential to limit or interfere with steering. These traits are undesirable in cycling.

Based on the foregoing, the present inventor has found that such limitations in bicycle lighting can be solved through the use of integrated, rechargeable and adjustable lighting. Lights should not be an accessory to a bicycle purchase, but should be directly integrated into the bicycle itself, thereby maximizing performance and safety of the rider. By utilizing modern technology, the present inventor presents a solution to the foregoing problems which solves these problems through a new, safe, efficient, reliable and useable bicycle lighting design.

### SUMMARY OF THE INVENTION

As stated above, visibility in dim light is a concern among cyclists. Riding without proper lights is hazardous on both open highways and city streets. Maximizing efficiency and performance is a trend in cycling that has yet to be established in conjunction with light fixtures. The invention claimed here solves this problem.

In one embodiment of the invention, the light fixtures are integrated directly into the components of the bicycle, creating a sleek aerodynamic design that ensures riders' safety.

In another embodiment of the invention, the light fixtures are bolted to the components of the bicycle, allowing for variable lighting placement positions and for easy replacement of light sources.

One benefit of the invention is that the design minimizes weight, and maximizes aerodynamics as well as rider safety.

In another embodiment of the invention, power is supplied to the lights by at least one rechargeable battery, electrical charging port, solar power, or a dyno generator hub.

A benefit of the invention is that the rechargeable and/or constantly recharging power cell ensures that the rider is never without power and can consistently accommodate a range of light intensities.

In another embodiment of the invention, the lights are adjustable, allowing for them to be directed in a variety of angles.

In another embodiment of the invention, the lights can be controlled so that they change intensity, turn on and off, intermittently illuminate, or illuminate in different colors.

In yet another embodiment of the invention, the power source is capable of powering other small electronic devices (e.g., cell phone), which is ideal for touring.

In another embodiment of the invention, the power source is removable from the bicycle.

In yet another embodiment of the invention, the rearward-facing tail lights can be powered by a power source and controlled via controls positioned at the front portion of the bicycle.

The above and other benefits of the invention are achieved as will now be further described.

### BRIEF DESCRIPTION OF THE DRAWINGS

FIG. 1 depicts a handlebar assembly illustrating a rivet-light assembly and a detachable bar-end in which preferred embodiments of the present invention may be implemented;

FIG. 2 depicts the handlebar assembly of FIG. 1, showing additional detail as to the handlebar rivet light assembly, including callout FIG. 2A, which illustrates additional features of the rivet light assembly, which may be utilized to implement preferred embodiments of the present invention;

FIG. 3 depicts an exploded view of the rivet light assembly, including illustration of individual components which may comprise the rivet light assembly in preferred embodiments of the present invention;

FIG. 4 depicts one end of the handlebar assembly depicted in FIG. 1, including additional illustrated detail as to the detachable bar-end assembly, in which preferred embodiments of the present invention may be implemented;

FIG. 5 illustrates an exploded view of the individual components, which may comprise the detachable bar-end assembly of FIG. 4 in preferred embodiments of the present invention;

FIG. 6 depicts a portion of the handlebar assembly which includes additional detail regarding another embodiment of the electrical top cap assembly;

FIG. 7 depicts a completed and cross-sectional view of the electrical top cap assembly;

FIG. 8 depicts a detailed view of the knurled top cap button which is a portion of the electrical top cap assembly;

FIG. 9 depicts a handlebar assembly, including a dyno junction box assembly, and illustrates in an exploded view components which may comprise the dyno junction box assembly in preferred embodiments of the present invention;

FIG. 10 illustrates an exploded view of the individual components which may comprise the dyno junction box of FIG. 9 in preferred embodiments of the present invention;

FIG. 11 depicts an exploded view of the components used in a tail light rivet assembly in preferred embodiments of the present invention;

FIG. 12 depicts an exploded view of the components used in a steer tube brush contact adhesive housing in preferred embodiments of the present invention;

FIG. 13 depicts an exploded view of the components used in a steer column brush contact gasket in preferred embodiments of the present invention;

FIG. 14 depicts two embodiments of a bolt-light assembly demonstrating that light connections may exit the bolt mid-way or at the end; and

FIG. 15 depicts an exploded view of the components used in the bolt-light assembly.

### DETAILED DESCRIPTION OF THE INVENTION

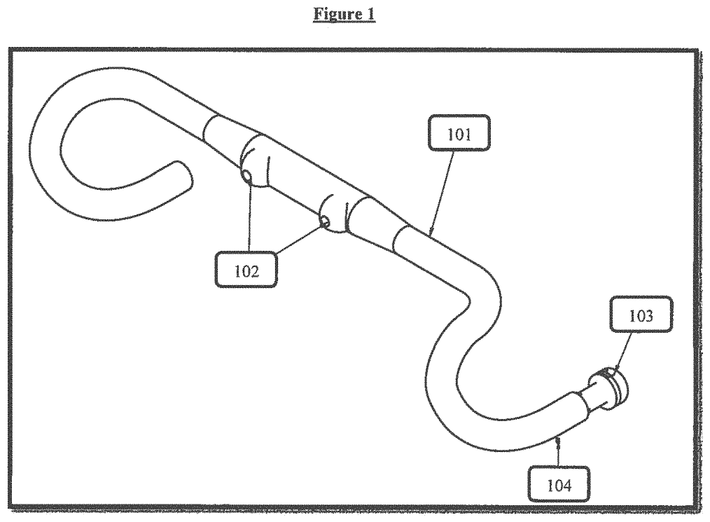

FIG. 1 depicts a handlebar assembly configured in one of the preferred embodiments of the present invention. Although not depicted in FIG. 1, the handlebar assembly may in some cases include the stem. In this embodiment, the handlebar (101) serves much like a normal handlebar would. The handlebar (101) is shaped as is common for many road bikes, but the present invention may be practiced utilizing a variety of other handlebar shapes and designs. The handlebar (101) may be used to anchor parts and conceal electrical connections.

FIG. 1 includes a rivet light assembly (102). Other embodiments of this invention encompass a bolt-light assembly. As indicated in FIG. 1, one embodiment of the invention includes a rivet light assembly with two LED light fixtures (102). Fewer or additional LED light fixtures (102) may be utilized to practice this invention. The LED light fixtures (102) can be directly installed during the manufacturing of the handlebar (101). Different LED arrangements could be made. Each LED light fixture (102) mounts to the handlebar (101). A single small incision, or multiple small incisions, may be made in the handlebar (101), in a manner that does not damage the integrity of the handlebar (101). This makes it possible to mount the rivet light assembly, including the LED light fixtures (102), and run the internal wiring. In one preferred embodiment of the present invention, these LED light fixtures (102) allow for illumination of the road in front of the bicycle and 30 degrees of angle adjustment. These LED light fixtures (102) hold LEDs, which can be used to illuminate the road in front of a bicycle. Other light sources and analogous fixtures may be substituted to practice the invention.

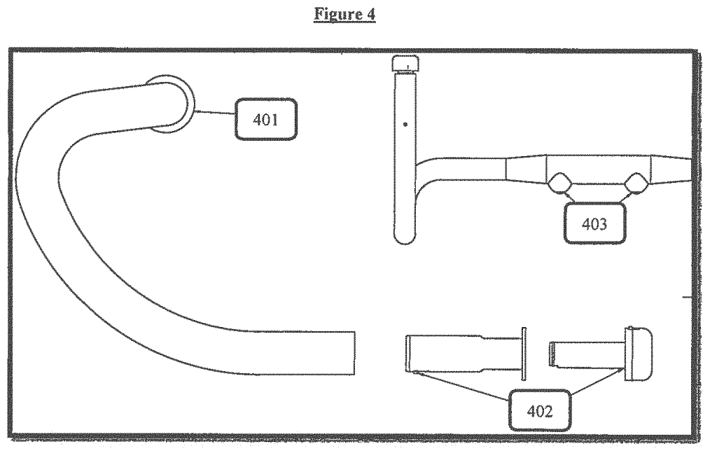

At one end of the handlebar (101) is the electrical bar-end (103). This element provides power to the LEDs. It is further depicted in other Figures as described below. In one preferred embodiment of the invention, a setscrew (104) is used to secure the electrical bar-end (103) in place and attach it to the handlebar (101). As depicted in FIG. 4, another preferred embodiment of the invention uses a snap fit fixture that engages a hole drilled into the handlebar (101). That embodiment accommodates riders' bar tape. That embodiment also prevents the misalignment of contacts and keeps the bar tape well wrapped.

The electrical bar-end (103) can be internally mounted rather than mounted to the bar-end (103).

The LED light fixtures (102) and, in many embodiments, all other elements depicted in FIG. 1, can be directly installed during the manufacturing of the handlebar (101). The handlebar (101) can be composed of a variety of materials, including steel and more commonly used modern day materials (e.g., carbon fiber, titanium, aluminum, wood and any and all future technology which will be expected to be used in the production of these products).

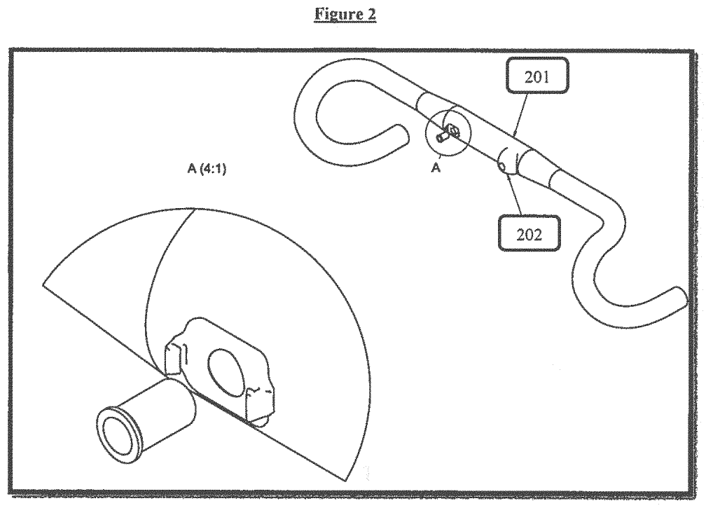

FIG. 2 depicts the handlebar rivet light assembly and illustrates additional detail regarding the rivet light assembly (FIG. 2A). In particular, FIG. 2 depicts a preferred embodiment of the invention consisting of a handlebar (201), onto which at least one rivet light assembly is secured (202). As illustrated in FIG. 2A, a snap fit flange is riveted into the handlebar (201) through insertion and application of a rivet nut.

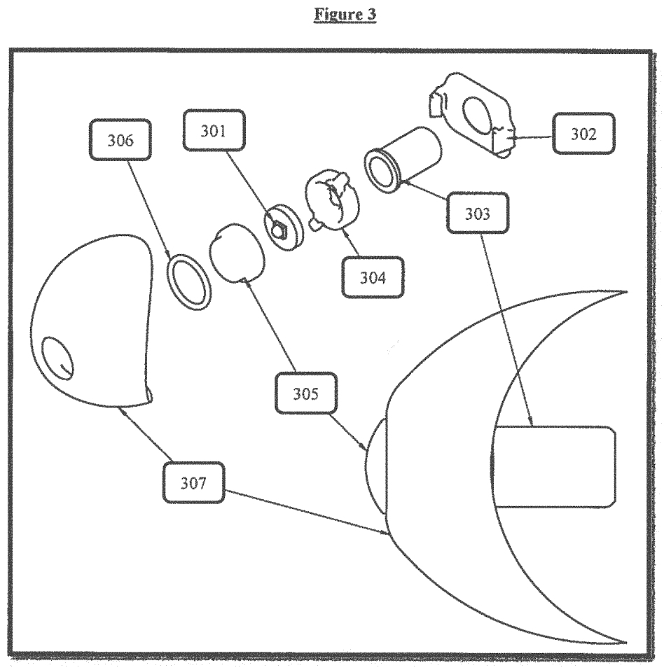

FIG. 3 depicts a preferred embodiment of the rivet light assembly of FIG. 1 and FIG. 2 (102; 202). In this embodiment, the rivet light assembly is comprised of seven elements. An LED circuit board is labeled element 301 (301). This element contains the LED, which provides the light that can be used to illuminate the ground in front of the bicycle. The power that is provided to this light can come from a variety of sources, including solar power sources, the electrical bar-end of the embodiment depicted in FIG. 1 (103) and a generator hub.

Element 302 of the embodiment depicted in FIG. 3 is a snap fit flange (302). The snap fit flange (302) may be connected directly to the handlebar (101; 201) of the embodiment in FIG. 1 and FIG. 2. The snap fit flange (302) serves as the anchor point of the rivet light assembly (102; 202), securing it to the handlebar (101; 201). In particular, a rivet nut (303) may be used to anchor the snap fit flange (302) to the handlebar (101; 201), as shown in the embodiments depicted in FIG. 1 and FIG. 2.

Once the rivet nut (303) has been used to secure the snap fit flange (302), an LED housing (304) is placed flush against the snap fit flange (302). The LED housing (304) contains the LED circuit board (301) and seals the enclosure, protecting the LED circuit board (301) from any outside contamination which might cause the LED circuit board (301) to cease functioning. When the LED circuit board (301) has been placed within the LED housing (304), a lens (305) will be located above it. The lens focuses the LED light stream, so that the light is properly directed. This focusing can allow for a variety of intensities and illumination cones. On top of the lens (305) is an o-ring (306). The o-ring (306) provides a seal which also prevents contaminants from entering the area where the LED circuit board (301) is housed.

Enclosing all of these elements is a faceplate (307). The faceplate contains elements, which connect to the snap fit flange (302), securing and concealing elements 1 through 6 of FIG. 3 in place. The faceplate (307) further provides an angle adjustment, allowing the light to be adjusted by the bicycle rider. The faceplate (307) may further include a solar panel for embodiments of the invention that utilize solar power. This panel may also be placed on the handlebar (101; 201).

FIG. 4 depicts a handlebar assembly configured in one of the preferred embodiments of the present invention. The handlebar (401) serves much like a normal handlebar would. The handlebar itself (401) is shaped as is common for many road bikes, but the present invention may be practiced utilizing a variety of other handlebar shapes and designs. The handlebar (401) may be used to anchor parts and conceal electrical connections.

FIG. 4 includes, at one end of the handlebar (401), an electrical bar-end and socket (402). The right-most portion of the electrical bar-end and socket (402) is the electrical bar-end. This portion provides power to the LEDs, which are mounted on the handlebar (401). The left-most portion of the electrical bar-end and socket (402) is the socket. This socket connects to the handlebar (401) via a snap fit fixture that engages a hole drilled into the handlebar (401). This accommodates riders' bar tape. This embodiment also prevents the misalignment of contacts and keeps the bar tape well wrapped. The power from the electrical bar-end is provided via connections made in the socket. Finally, the rivet light assembly (403) contains the LEDs and the other elements necessary to connect those light sources to the handlebar (401) and make those lights usable by the rider.

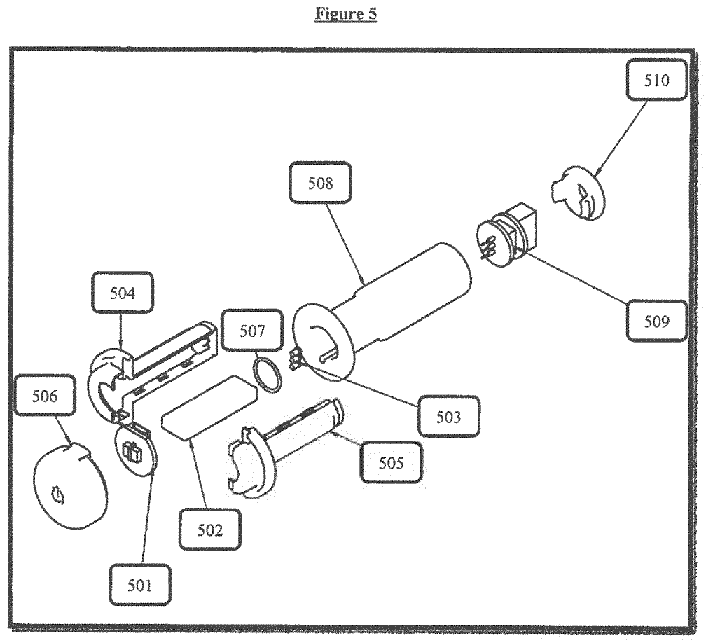

FIG. 5 depicts an embodiment of the electrical bar-end and socket (402) in additional detail. This embodiment includes a USB/button circuit board (501). This element contains a button which may be used by the rider to activate functionality of the LED s, a circuit board for appropriately interpreting and triggering electrical signals and also a USB charge port. In one embodiment, USB/button circuit board (501) is covered by a USB/button cover (506). This USB/button cover (506) may be pressed by the rider to activate the functionality of the USB/button circuit board (501), without the potential for damaging the electronics. In one embodiment, the circuit board is hardwired to the LEDs and the button. In some embodiments, the circuit board has pre-programmed logic gates that are controlled by button press. For example, in another embodiment, an extended press turns the light on/off. In another embodiment, successive pushes after power-on run through different light functions (e.g., high, bright, dim, strobe, fade).

By way of example, in one embodiment, the button on the USB/button circuit board (501) will power on/off the light sources when pressed and held for 1 second or longer. The customer can then toggle through the light settings with additional button presses. When the battery (502) runs out of power it can be removed and charged via a computer USB. If either a generator or solar panel (or both) is present, then the battery (502) does not need to be removed when depleted.

In some embodiments, the circuit board must first be programmed before installation. This may be done with a programming board (perhaps the circuit board itself). The connections from the circuit board to other components may be soldered together.

The electrical bar-end and socket (402), one of the embodiments of which is depicted in further detail in FIG. 5, includes a battery (502). Different types of power cells can be used as the battery (502). This battery (502) may, in some embodiments, require programming and indication lights to notify riders of the state of the battery (502) (e.g., fully charged/low). The battery (502) can be removed for charging purposes as well as for external usage Likewise, in some embodiments, the battery could actually be comprised of multiple power sources so that a fresh power source may be substituted when the previous power source is depleted. In some embodiments, the battery (502), the USB/button circuit board (501) and the USB/button cover (506) can all be made into a single unit. In some embodiments, the battery (502) has a female USB adapter that plugs into a internally routed USB contained in the USB/button circuit board (501). As depicted in the embodiment shown in FIG. 5, contacts (503) can be placed at the end of the battery (502), opposite the USB/button circuit board (501). These contacts (503) must be designed so that they mate with the contacts/IC circuit board (509) that provides power directly to the LEDs.

Elements 501,502 and 503 of FIG. 5 are surrounded on either side by electrical housing (504; 505). The USB/button cover secures the USB/button circuit board (501) to protect it from contamination, accidental touching and from falling out of the bicycle when in use. On the other end, an o-ring (507) prevents contaminants from entering the electrical housing (504; 505). Taken together, Elements 501-507 make up one embodiment of the electrical bar-end discussed above in the description of FIG. 4. The contact (503) must be such that, when the electrical bar-end is slid into the socket, it mates and is properly connected to the contacts/IC circuit board identified as element 509.

Different circuit configurations could be attempted to make simpler circuits both on the LEDs, battery (502), and USB/button circuit board (501). Different coded sequences can be written for LED function. The USB/button cover (506) can be made fully detachable. Different types of lights can be used other than LEDs. The connection between the USB/button circuit board (501) can be made wireless through use of common wireless technology.

One embodiment of the socket discussed above in the discussion of FIG. 4 is comprised of elements 8-10 depicted in FIG. 5. The socket consists of a socket housing (508), into which the electrical bar-end may be placed. At the end of the socket housing (508) is placed the contacts/IC circuit board (509), which serves as the point of electrical contact between the electrical bar-end (specifically, the Contact (503)) and the connection to the LEDs. Finally, to enclose the end of the socket housing (508) is the socket rear cap (510), which prevents debris and contaminants from entering inside the handlebar (e.g., 101) or the socket.

In another embodiment of the present invention, an internal USB cord plugs into the battery (502) and runs to the bar-end, where it is fastened in place by a wedged stopper and setscrew. The wedged stopper provides a port into which the battery (502) may plug. The internally routed USB cable and stopper are connected to a programmed circuit board and run to the handlebar end.

A generator hub or solar panels may be incorporated in various embodiments of the present invention. They would charge the battery (502) for later use. The generator or solar panels are able to be used individually or together. In addition to a female USB mini adapter required for charging in instances without generator hubs or solar panels, a solar panel would be integrated into the LEDs, programmed by a programmable circuit to store a charge in the battery (502). The generator hub would function in a similar manner, storing energy in the battery (502). This utilization of a generator hub and/or solar panel to store power in the battery (502) is generally applicable to a variety of embodiments of the present invention. These two elements (the generator hub and solar panels) can be of great use in instances of touring when power supply is limited. They would provide power to the battery (502), which could be used to power the bicycle's LEDs or other electronic devices.

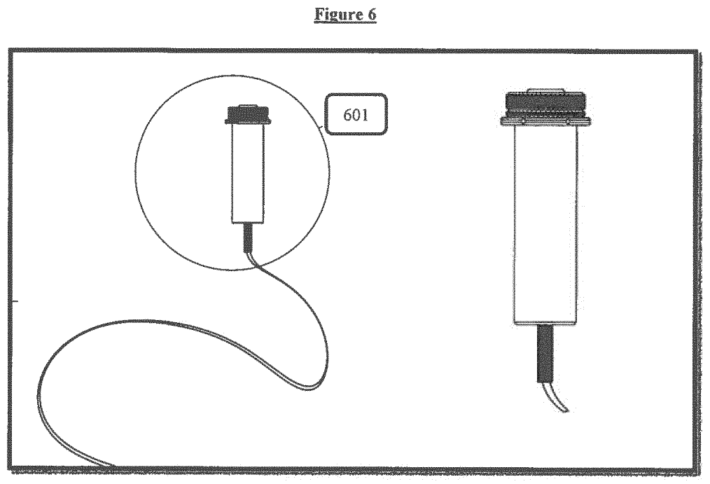

FIG. 6 depicts a handlebar assembly configured in one of the preferred embodiments of the present invention called an electrical top cap. In particular, the handlebar assembly, including the electrical coupling and electrical top cap assembly is enclosed in the circle (601) depicted. The electrical top cap assembly featured in FIG. 6 is a preferred embodiment of the cap that can be used with the handlebar assembly for practicing the invention.

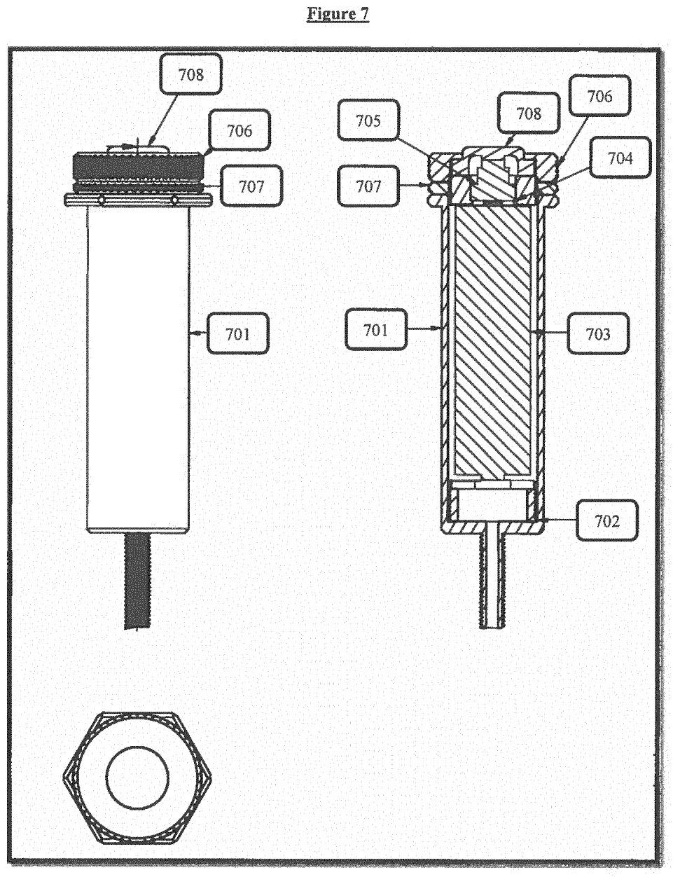

FIG. 7 depicts multiple views of the handlebar assembly with the modified electrical top cap assembly depicted in FIG. 6. The left view is an outer view, the right view is a cross-sectional view, and the bottom left is a view from above. FIG. 7 depicts the electrical top cap (701) which, in some embodiments, includes a M6×1 bolt located at the base of the top cap shaft which threads into a starnut located in the fork steer tube. The M6 bolt located at the bottom of the electrical top cap can be substituted for the components required to make a compression plug. This is necessary in the instance the system is installed in fork with a carbon steer tube. The shoulder on top of the shaft is hexagonal, as depicted in the portion of FIG. 7 on the bottom left, allowing a wrench head to tighten. At the bottom of the electrical top cap (701) is the LED driver circuit and housing (702). This provides electrical continuity between the LEDS and battery. Directly above is the battery (703) which provides power for the light sources and their associated functionality. For example, a 18650 Li-Ion battery may be used.

On top of the battery (703) and surrounding the button and spring contact (705) is the button cap threaded component (704). This may, in some embodiments, consist of a M22×1 threaded body. The button cap threaded component (704) surrounds the button and spring contact (705) and interlocks with the knurled button top (706) and the jamnut (707). The button and spring contact (705) may be compressed by pressing from above, activating functionality programmed into the LED driver circuit and housing (702) which is powered by the battery (703). The knurled button top (706) screws on top of the button cap threaded component (704) and conceals the button and silicon button cap (708). The knurled button top (706) provides a bearing surface to unscrew from the electrical top cap assembly in order to access the battery (703). The jamnut (707) brushes against the knurled button top (706) and prevents the button cap threaded component (704) from unscrewing into the electrical top cap (701). Finally, the silicon button cap (708) insulates the button from contaminants like dirt, debris, or precipitation.

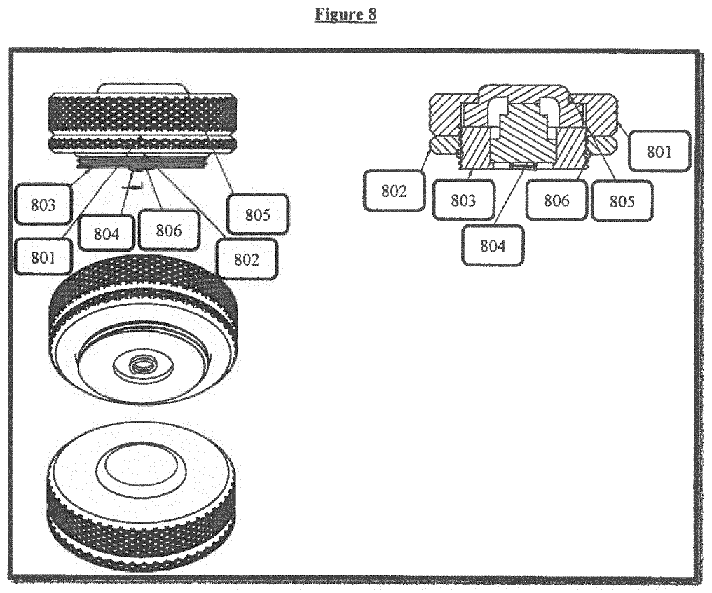

FIG. 8 depicts a close-up view of the top portion of FIG. 7. In particular, FIG. 8 depicts the knurled button top (801), the knurled jamnut (802), the button cap threaded component (803), the button and spring contact (804), the silicon button cap (805), and the o-ring (806). The components fit together much as taught above in the detailed description of FIG. 7. In particular, the knurled button top (801) screws atop the button cap threaded component (803), concealing the button and spring contact (804) as well as the silicon button cap (805). The knurled button top also provides a bearing surface to unscrew from the electrical top cap assembly in order to access the battery. The o-ring (806) seals the electrical components from dirt, debris, and precipitation. It wraps around and below the knurled jamnut (802).

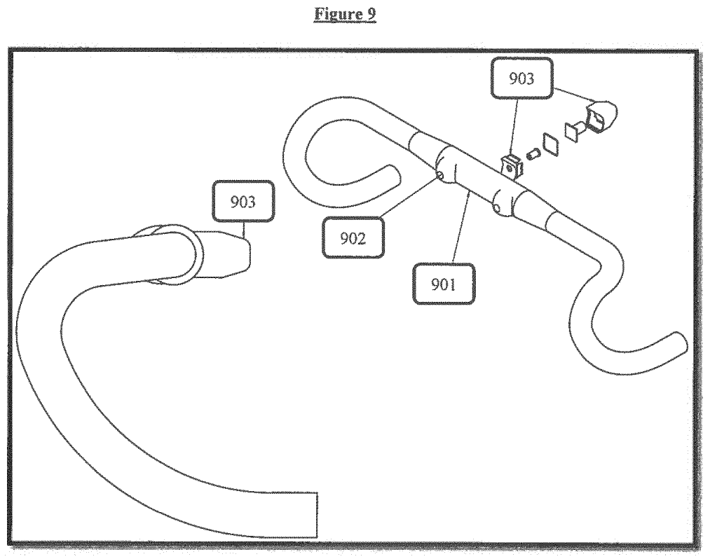

Another preferred embodiment of the present invention includes a dyno generator. In this embodiment, an electrical dyno generator is attached to one of the wheels (e.g., the front wheel) of the bicycle. This dyno generator may be used to generate some or all of the power necessary to power the LEDs. The dyno generator may be used alone, or in conjunction with a conventional solar panel. Depicted in FIG. 9 is an embodiment of the handlebar/dyno junction box assembly. This embodiment includes a handlebar (901) and rivet light assembly (902). In this embodiment, the rivet light assembly (902) is secured to the center of the handlebar (901), but, in other embodiments, it is possible that other orientations may be used. Centered on the rivet light assembly (902) and on the side not facing the LEDs, in this embodiment, is attached the dyno junction box assembly (903). The dyno junction box assembly (903) provides electrical contact between the dyno hub (which gains electrical energy from the wheels) and the headlights.

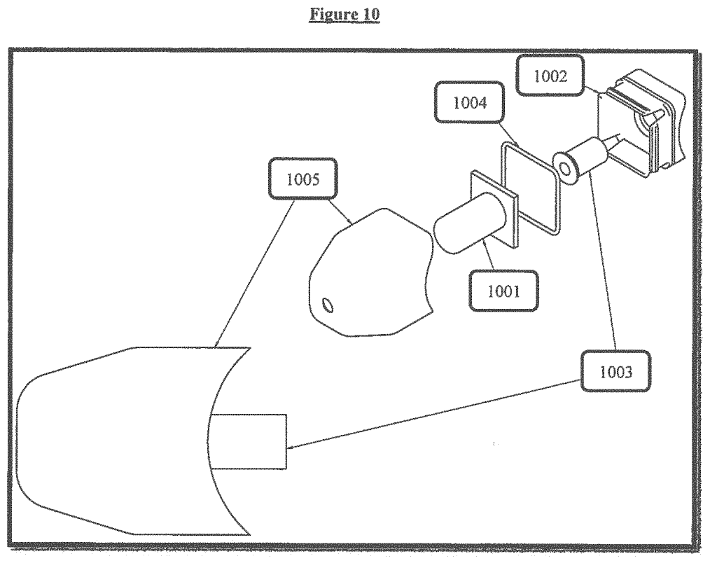

Further detail of the internal workings of the dyno junction box assembly (903) is illustrated in FIG. 10. In particular, the dyno junction box assembly (903) includes a dyno circuit board (1001). This element provides power from the dyno hub to the LEDs. The dyno circuit board (1001) is protected from contamination on either end by a water-tight gasket (1004) on one end and a junction box cover (1005) on the other end. The junction box cover (1005) attaches to the snap fit flange (1002) to completely house the dyno circuit board (1001). In this embodiment, a rivet nut (1003) is used to anchor the snap fit flange (1002) to the handlebar (e.g., 901).

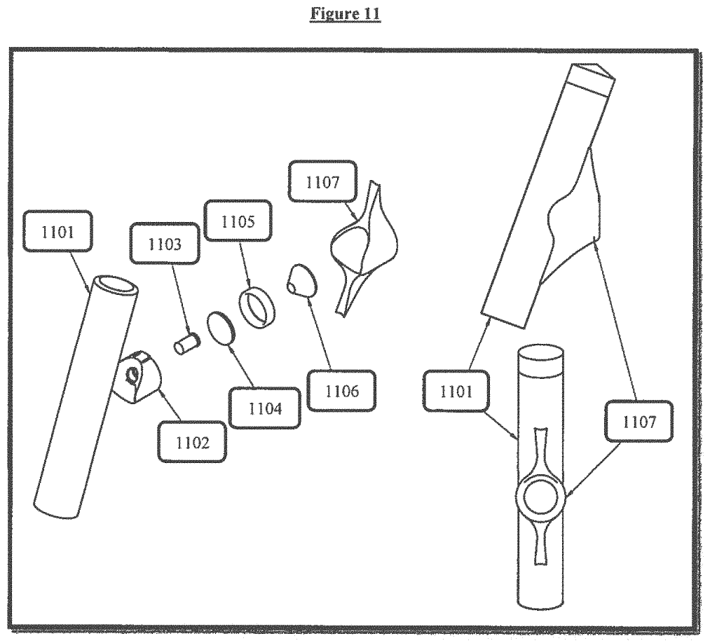

Another preferred embodiment of the present invention, which includes a tail light rivet assembly for use in a rearward-facing tail light, is depicted in an exploded view in FIG. 11. In particular, the rearward-facing tail light is mounted onto the seat-post (1101). A snap fit flange (1102) is used as an anchor point for the tail light fixture and secured to the seat-post (1101) with a rivet nut (1103). The snap fit flange (1102) contains an LED circuit board (1104), which is comprised of an LED or alternative light source and circuitry. The power provided to the light source can come in the forms discussed above (e.g., solar, generator hub, battery, some combination of these). The LED circuit board (1104) is sealed into the tail light rivet assembly using a gasket (1105), which provides a water-tight seal. The light source is focused with a lens (1106), and ultimately covered and secured to seat-post (1101) with a tail light faceplate (1107), which provides a sleek, aerodynamic and safe housing. In some embodiments, this tail light faceplate (1107) may be designed to prevent contamination from reaching the LED circuit board (1104) or to prevent the tail light rivet assembly from becoming attached to any outside material.

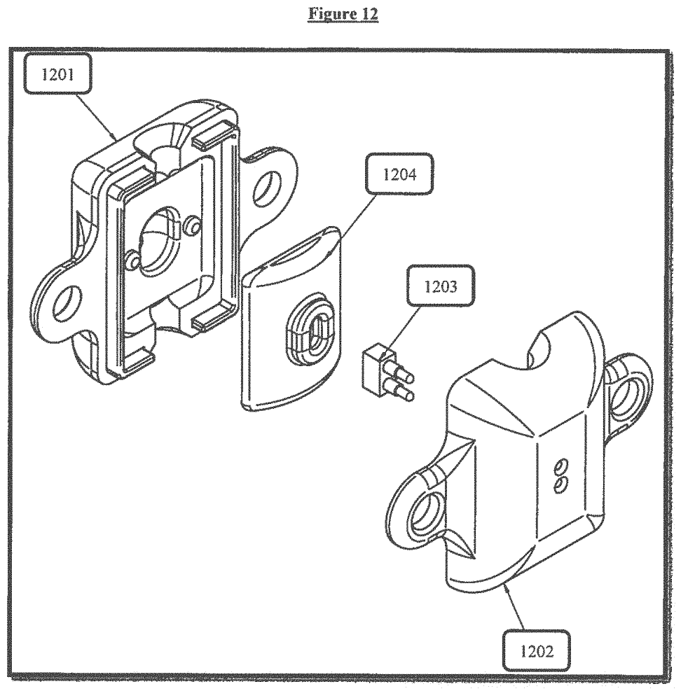

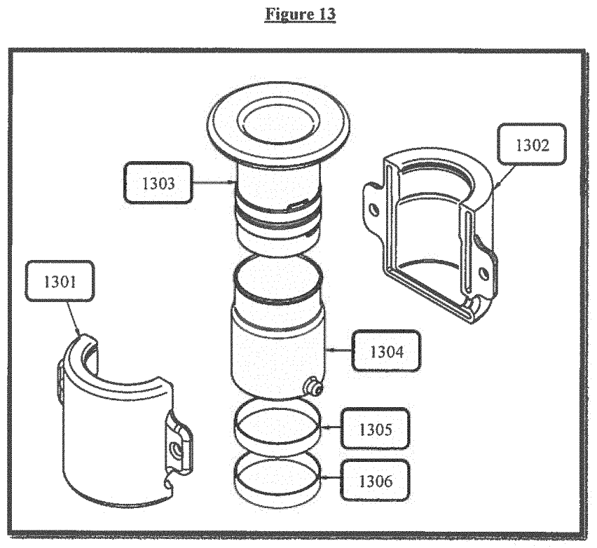

In some preferred embodiments, power is supplied to the rearward-facing tail light from power sources mounted on the handlebars or front wheel of the bicycle. In a preferred embodiment of the invention, that power is transferred without interfering with steering and in a manner integrated into the bicycle as depicted in FIG. 12 and FIG. 13.

FIG. 12 depicts an exploded view of the steer tube brush contact adhesive housing. The housing is formed using two steer tube brush contact molds (1201; 1202). In some preferred embodiments of the invention, silicone resin mold may be poured into these molds which surround the handlebar support post. Prior to pouring silicone, the steer tube brush contacts (1203) are inserted into the steer tube brush contact molds (1201; 1202). After slotting the steer tube, the steer tube brush contact adhesive housing (1204) can be inserted using a spanner wrench. The steer tube brush contact adhesive housing (1204) provides continuity between the steer tube brush contacts (1203) and the contact point of the steer column gasket (1305; 1306).

FIG. 13 depicts an exploded view of the steer column brush contact gasket. This is formed by pouring a silicone resin mold into the steer column gasket molds (1301; 1302; 1303). This silicone resin mold will contain the other elements of the steer column brush contact gasket. In particular, this includes a negative contact (1306) and positive contact (1305), which are insulated from each other and the bicycle frame by the silicone resin mold. Moreover, these elements are connected to an adhesive backed silicon gasket (1304), which houses the electrical contact points and allows a cable to be routed through the bicycle's top tube and provides power to rearward-facing tail lights from elements which are mounted near the handlebars or the steering column.

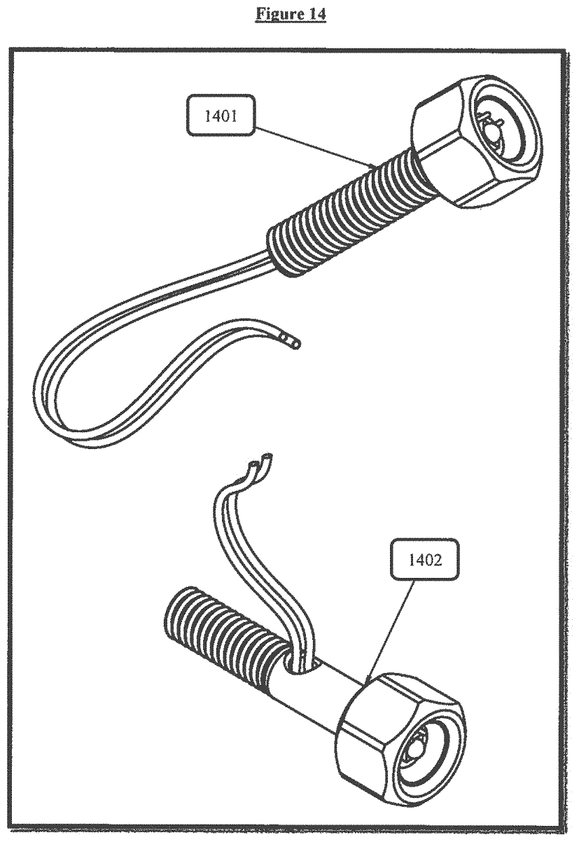

FIG. 14 depicts two preferred embodiments of the invention which attaches the light source to the bicycle by way of a bolt connection. These bolts have a light source attached to the head of the bolt and an electrical coupling to the light source which passes at least part of the way through the bolt. In particular, the bolt may be such that the electrical coupling passes through the entire length of the bolt (1401) or only a portion of the way through the bolt (1402). Passage of the electrical coupling through the entire bolt stem (1401) is well-suited for use with cantilever brakes and other portions of the bicycle. Passage of the electrical coupling through only a portion of the bolt stem (1402) streamlines the use of electrical coupling (e.g., wire) and is well-suited for use in the brake bolt hole of a bicycle fork crown. One preferred embodiment uses 12 mm hex bolt m6×1 which is hollowed at least partially to allow the electrical coupling to pass through.

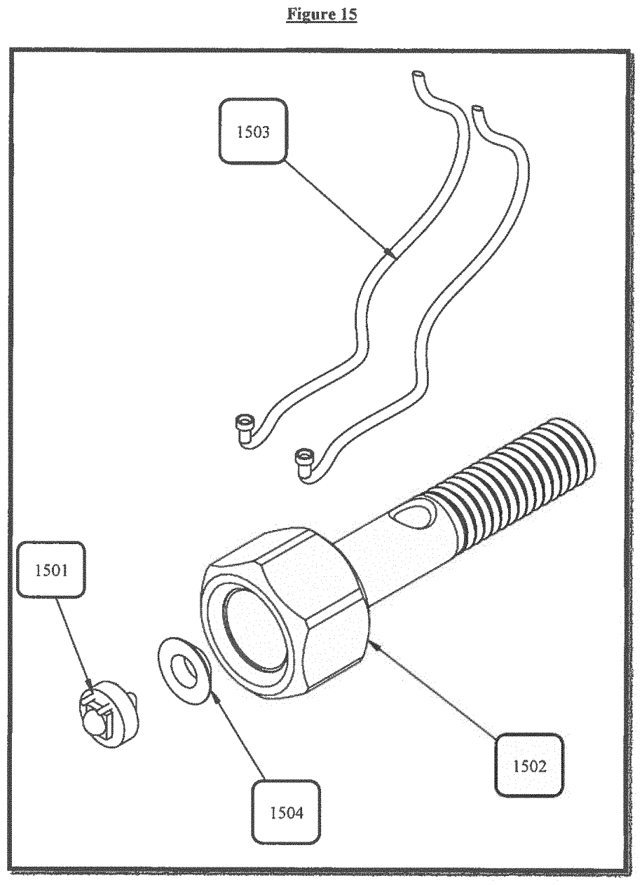

FIG. 15 depicts an exploded view of the components of the LED bolt assembly. In particular, it explodes the embodiment depicted in FIG. 14 which provides for electrical coupling to pass partially through the bolt (1402). This embodiment contains a lens which focuses the light produced by the LED circuit board (1501). The LED circuit board (1501) has quick connect electrical pins allowing for easy replacement of the LED. A person of ordinary skill in the art would be capable of substituting an alternative light source to replace the LED. The LED circuit board (1501) is inserted into the top of the bolt (1502). In FIG. 15, a 12 mm hex bolt with m6×1 thread is depicted. The bolt head is bored out to accept the LED circuit board (1501) and lens. A 3 mm hole may be drilled through the shaft of the bolt (1502) to create a passage that allows electrical coupling (e.g., wires) to make contact with the LED circuit board (1501) and travel through at least part of the bolt (1502) stem. LED leads (1503) are connected to the LED circuit board (1501) in the steer tube. Finally, a gasket (1504) is placed between the LED circuit board (1501) and the bolt (1502) head to seal the bolt internally and prevent contaminants from entering.

A consumer would use the above described embodiments much like any other handlebar or seat-post. Installation would be equivalent to a modern handlebar or seat-post. Additionally, the battery (502) can be used to charge other small electronic devices.

The present invention has been described in accordance with the embodiments shown, and one of ordinary skill in the art will readily recognize that there could be variations to the embodiments and any variations would be within the spirit and scope of the present invention. Accordingly, many modifications may be made by one of ordinary skill in the art without departing from the spirit and scope of the appended claims.

What is claimed is:

1. A bicycle lighting assembly comprising:
at least one bolt capable of being attached to the bicycle in a removable manner;
at least one light source integrally mounted onto each bolt;
at least one battery integrally mounted in the handlebar assembly or steer tube of the bicycle; and
a mechanism electrically coupled to the at least one battery and the at least one light source for controlling the at least one light source, said mechanism integrated into the handlebar assembly or steer tube.

2. The bicycle lighting assembly of claim 1, wherein:
the at least one light source is mounted on a handlebar assembly or steer tube such that it is capable of illuminating an area in front of the bicycle.

3. The bicycle lighting assembly of claim 1, wherein:
the at least one light source is mounted on the rear portion of the bicycle such that it is capable of illuminating an area behind the bicycle; and
said at least one light source is electrically coupled to the battery utilizing a steer tube brush contact connection.

4. The bicycle lighting assembly of claim 1, wherein:
the at least one bolt is configured such that the at least one light source is connected to the at least one battery via one of the following mechanisms:
the electrical coupling to the at least one light source passes through the entire length of the at least one bolt; or
the electrical coupling to the at least one light source passes through approximately one half of the length of the at least one bolt.

5. The bicycle lighting assembly of claim 1, wherein:
the at least one battery is chargeable by one or more of the following elements:
an electrical charging port;
a dyno generator attached to a wheel of the bicycle; or a solar panel mounted on the bicycle.

6. The bicycle lighting assembly of claim 1, wherein:
the at least one light source is composed of an LED.

7. The bicycle lighting assembly of claim 1, wherein:
the at least one light source is configured such that it can be adjusted in one or more of the following ways:
the intensity of the light emanating from the at least one light source may be adjusted;
the at least one light source can either emanate light or not emanate light;
the at least one light source can be intermittently illuminated; or
the at least one light source can be adjusted to emanate light of different colors.

8. The bicycle lighting assembly of claim 1, wherein:
the at least one light source and at least one bolt can be configured to allow the angle of the light emanating from the at least one light source to be adjusted within a cone having an angle of 30 degrees.

9. The bicycle lighting assembly of claim 1, wherein:
the at least one battery is removable.

10. The bicycle lighting assembly of claim 1, wherein:
the at least one battery includes additional electrical coupling capability allowing for the charging of at least one electronic device.

11. A bicycle lighting assembly comprising:
at least one rivet capable of being attached to the bicycle;
at least one light source integrally mounted onto each rivet;
at least one battery integrally mounted in the handlebar assembly or steer tube of the bicycle; and
a mechanism electrically coupled to the at least one battery and the at least one light source for controlling the at least one light source, said mechanism integrated into the handlebar assembly or steer tube.

12. The bicycle lighting assembly of claim 11, wherein:
the at least one light source is mounted on a handlebar assembly or steer tube such that it is capable of illuminating an area in front of the bicycle.

13. The bicycle lighting assembly of claim 11, wherein:
the at least one light source is mounted on the rear portion of the bicycle such that it is capable of illuminating an area behind the bicycle; and
said at least one light source is electrically coupled to the battery utilizing a steer tube brush contact connection.

14. The bicycle lighting assembly of claim 11, wherein:
the at least one battery is chargeable by one or more of the following elements:
an electrical charging port;
a dyno generator attached to a wheel of the bicycle; or
a solar panel mounted on the bicycle.

15. The bicycle lighting assembly of claim 11, wherein:
the at least one light source is composed of an LED.

16. The bicycle lighting assembly of claim 11, wherein:
the at least one light source is configured such that it can be adjusted in one or more of the following ways:
the intensity of the light emanating from the at least one light source may be adjusted;
the at least one light source can either emanate light or not emanate light;
the at least one light source can be intermittently illuminated; or
the at least one light source can be adjusted to emanate light of different colors.

17. The bicycle lighting assembly of claim 11, wherein:
the at least one light source and at least one rivet can be configured to allow the angle of the light emanating from the at least one light source to be adjusted within a cone having an angle of 30 degrees.

18. The bicycle lighting assembly of claim 11, wherein:
the at least one battery is removable.

19. The bicycle lighting assembly of claim 11, wherein:
the at least one battery includes additional electrical coupling capability allowing for the charging of at least one electronic device.
